(19) United States
(12) Patent Application Publication
(10) Pub. No.: US 2025/0276938 A1
(43) Pub. Date: Sep. 4, 2025

(54) DRY MORTAR COMPOSITION CONTAINING METAL SALT OF A POLYOL

(71) Applicant: BASF SE, Ludwigshafen am Rhein (DE)

(72) Inventors: Harald GRASSL, Trostberg (DE); Joachim DENGLER, Trostberg (DE); Alexander SCHOEBEL, Trostberg (DE)

(21) Appl. No.: 18/863,670

(22) PCT Filed: May 2, 2023
(86) PCT No.: PCT/EP2023/061444

§ 371 Date: Nov. 7, 2024

(30) Foreign Application Priority Data
May 9, 2022 (EP) 22172257.2

(51) Int. Cl. C04B 28/04; C04B 22/10; C04B 24/02; C04B 24/04; C04B 28/06; C04B 28/14

(52) U.S. Cl. CPC C04B 28/04; C04B 22/10; C04B 24/02; C04B 24/04; C04B 28/06; C04B 28/14

(57) ABSTRACT

The present invention relates to a dry mortar composition comprising (a) a cementitious binder comprising one or more calcium silicate mineral phases and one or more calcium aluminate mineral phases, (b) a metal salt of a polyol, wherein the polyol is selected from monosaccharides, oligosaccharides, water-soluble polysaccharides, compounds of general formula (P-I) or dimers or trimers of compounds of general formula (P-I); (c) optionally, an extraneous alumina source; (d) a sulfate source; wherein the composition comprises (c) available aluminate, calculated as Al(OH)₄—, from the calcium aluminate mineral phases plus the optional extraneous aluminate source, per 100 g of cementitious binder a), in a total amount of at least 0.05 mol; and the molar ratio of total available aluminate to sulfate is 0.4 to 2.0; the composition further comprising (f) an ettringite formation controller comprising (i) hydroxy carboxylic acid, glyoxylic acid, a glyoxylic acid salt, a hydroxycarboxylic acid or derivative or salts thereof and/or a glyoxylic acid derivative and salts thereof; and/or mixtures of the aforementioned and (ii) a carbonate source, wherein the carbonate source is selected from inorganic carbonates, preferably having an aqueous solubility of 0.1 g·L⁻¹ or more at 25° C.; organic carbonates; and mixtures thereof. The invention further relates to a mixed mortar composition comprising the dry mortar composition and water as well as an article obtained by the mixed mortar composition.

The present invention relates to a dry mortar composition comprising (a) a cementitious binder comprising one or more calcium silicate mineral phases and one or more calcium aluminate mineral phases, (b) a metal salt of a polyol; (c) optionally, an extraneous alumina source; (d) a sulfate source; and an ettringite formation controller comprising. The invention further relates to a mixed mortar composition comprising the dry mortar composition and water as well as an article obtained by the mixed mortar composition.

Polyols, in particular glycerin, are raw materials in many dry mortars. However, since glycerin is a liquid and not a solid, it must be presented in powder form.

WO2020/0173723 A1 discloses a construction material comprising a mixture containing at least one compound A selected from glyoxylic acid, salts thereof, and condensation or addition products of glyoxylic acid or salts thereof; and at least one polyhydroxy compound B.

WO2022/043347 A describes a construction composition comprising a cementitious binder, optionally, an extraneous aluminate source, a sulfate source, an ettringite formation controller and a polyol.

In WO2022/043348 A1, a cement-reduced construction composition comprising a cementitious binder, a fine material, a polyol, an ettringite formation controller and a co-retarder is described.

WO2022/043349 A1 discloses a limestone calcined cement construction composition comprising a cementitious binder, a supplementary cementitious material, optionally, an extraneous aluminate source; a sulfate source, a polyol, an ettringite formation and a co-retarder

In WO 2022/043350 A1, a construction composition containing a cementitious binder comprising one or more calcium silicate mineral phases and one or more calcium aluminate mineral phases, optionally, an extraneous aluminate source, a sulfate source, and a set control composition comprising a polyol is described.

In the application of cementitious flowing screed, robust and constant hardening is an important criterion. A system that accelerates over time is more difficult for the processor to handle.

Pure spraying onto the cement surface or the dry mortar mixture is not feasible, as this would lead to strong aging effects during storage of dry mortar in the cement bag or silo. Hydration then accelerates strongly and workability over time drops dramatically.

Therefore, it was an object of the invention to provide a dry mortar composition having constant setting time while exhibiting a comparable comprehensive strength.

It has been surprisingly found that the above-mentioned object can be solved by:

Item 1: A dry mortar composition comprising
(a) a cementitious binder comprising one or more calcium silicate mineral phases and one or more calcium aluminate mineral phases,
(b) a metal salt of a polyol, wherein the polyol is selected from monosaccharides, oligosaccharides, water-soluble polysaccharides, compounds of general formula (P-I) or dimers or trimers of compounds of general formula (P-I);

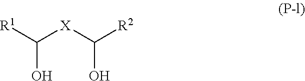

wherein X is

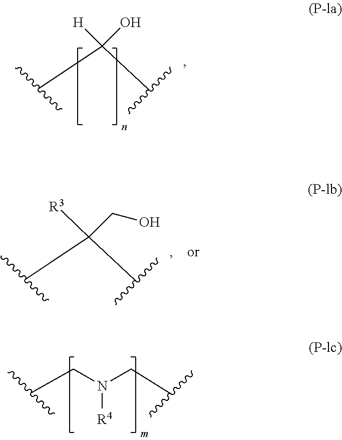

wherein
R¹ is —H, —CH₃;
R² is —H, —CH₃;
R³ is —CH₂OH, —NH₂;
R⁴ is —H, —(CH₂)ₚCH₂OH, —(CH₂)ₛCH(OH)CH₃;
m is an integer from 1 to 4;
n is an integer from 1 to 8;
p is an integer from 1 to 4;
s is an integer from 1 to 4;
(c) optionally, an extraneous alumina source;
(d) a sulfate source;
Wherein the composition comprises
(e) available aluminate, calculated as Al(OH)₄⁻, from the calcium aluminate mineral phases plus the optional extraneous aluminate source, per 100 g of cementitious binder a), in a total amount of at least 0.05 mol;
and the molar ratio of total available aluminate to sulfate is 0.4 to 2.0;
the composition further comprising
(f) an ettringite formation controller comprising (i) glyoxylic acid, a glyoxylic acid salt, a hydroxycarboxylic acid or derivative or salts thereof and/or a glyoxylic acid derivative and salts thereof; and/or mixtures of the aforementioned and (ii) a carbonate source, wherein the carbonate source is selected from inorganic carbonates, preferably having an aqueous solubility of 0.1 g·L⁻¹ or more at 25° C.; organic carbonates; and mixtures thereof.

Item 2: The composition according to item 1, wherein the composition additionally comprises a co-retarder (g) selected from (g-1) phosphonic acids and salts thereof, (g-2) polycarboxylic acids and salts thereof; and mixtures thereof.

Item 3: The composition according to item 1 or 2, wherein the composition additionally comprises (h) a fine material having a Dv90 of less than 200 μm, preferably of less than 150 μm, selected from alkali-activatable binders, rock powders and inorganic pigments, or mixtures thereof, in a total amount of 20 to 200 parts by weight, relative to 100 parts by weight of cementitious binder (a).

Item 4: The composition according to any of the preceding items, wherein the metal salt of the polyol (b) is present in an amount of 0.15-2.5 wt.-% relative to the amount of the cementitious binder (a).

Item 5: The composition according to any of the preceding items, wherein the calcium salt of the polyol (b) is present in a crystalline or amorphous form.

Item 6: The composition according to any of the preceding items, wherein the metal salt of the polyol (b) is a calcium salt of compounds of general formula (P-I) or dimers or trimers of compounds of general formula (P-I), preferably a calcium salt of compounds of general formula (P-Ia), more preferably calcium glycerolate or the calcium salt of triethanolamine, and especially preferably calcium glycerolate.

Item 7: The composition according to any of the preceding items, wherein
the binder (a) is present in an amount of 180 to 900 kg per m³ of the freshly mixed mortar composition, and/or
the binder (a) has a Blaine surface area of at least 3800 cm²/g, preferably of at least 4500 cm²/g.

Item 8: The composition according to any of the preceding items, wherein available aluminate, calculated as Al(OH)₄, from the calcium aluminate mineral phases plus the optional extraneous aluminate source, per 100 g of cementitious binder (a), in a total amount of not more than 0.2 mol.

Item 9: The composition according to any of the preceding items, wherein the calcium aluminate mineral phases are selected from C3A, C4AF, and C12A7, in particular C3A and C4AF.

Item 10: The composition according to any of the preceding items, wherein the cementitious binder (a) is Portland cement, in particular ordinary Portland cement (OPC).

Item 11: The composition according to any of the preceding items, wherein the sulfate source (d) is a calcium sulfate source, preferably calcium sulfate anhydride.

Item 12: The composition according to any of the preceding items, wherein the inorganic carbonate is selected from potassium carbonate, sodium carbonate, sodium bicarbonate, lithium carbonate and magnesium carbonate; and the organic carbonate is selected from ethylene carbonate, propylene carbonate and glycerol carbonate.

Item 13: The composition according to any of the preceding items, wherein the extraneous aluminate source (c) is selected from non-calciferous aluminate sources, such as aluminum(III) salts, aluminum(III) complexes, crystalline aluminum hydroxide, amorphous aluminum hydroxide; and calciferous aluminate sources such as high alumina cement, sulfoaluminate cement or synthetic calcium aluminate mineral phases.

Item 14: The composition according to any one of the preceding items, wherein the composition additionally comprises a dispersant, preferably the dispersant being selected from the group consisting of
comb polymers having a carbon-containing backbone to which are attached pendant cement-anchoring groups and polyether side chains,
non-ionic comb polymers having a carbon-containing backbone to which are attached pendant hydrolysable groups and polyether side chains, the hydrolysable groups upon hydrolysis releasing cement-anchoring groups,
colloidally disperse preparations of polyvalent metal cations, such as Al³⁺, Fe³⁺ or Fe²⁺, and a polymeric dispersant which comprises anionic and/or anionogenic groups and polyether side chains, and the polyvalent metal cation is present in a superstoichiometric quantity, calculated as cation equivalents, based on the sum of the anionic and anionogenic groups of the polymeric dispersant,
sulfonated melamine-formaldehyde condensates,
lignosulfonates,
sulfonated ketone-formaldehyde condensates,
sulfonated naphthalene-formaldehyde condensates,
phosphonate containing dispersants,
phosphate containing dispersants, and
mixtures thereof.

Item 15: The composition according to any one of items 3 to 14, wherein
the alkali-activatable binder is selected from latent hydraulic binders and pozzolanic binders, and/or
the rock powder is a silicate or carbonate rock powder, preferably selected from limestone, dolomite, basalt and quartz powder, and/or
the inorganic pigment is selected from iron oxides, titanium dioxide, cobalt-chrome-aluminum-spinels, and chrome (III)-oxides.

Item 16: A mixed mortar composition comprising the dry mortar composition according to any one of items 1 to 15 and water, wherein the ratio of water to cementitious binder (w/c) is from 0.2-1.5, preferably 0.3-1.

Item 17: An article obtained by the mixed mortar composition according to item 16.

The inventors surprisingly found that by using metal salts of polyols, such as calcium glycerolate, a dry mortar composition having constant setting time while exhibiting a comparable comprehensive strength could be obtained. In particular, a powder is formed from the liquid polyol after neutralization. When the polyol was added as calcium salt of a polyol to the rest of the components of the dry mortar composition, no aging of the dry mortar occurred, and the dry mortar could be stored stably in a bag for several months.

The dry mortar composition of the invention comprises
(a) a cementitious binder comprising one or more calcium silicate mineral phases and one or more calcium aluminate mineral phases,
(b) a metal salt of a polyol, wherein the polyol is selected from monosaccharides, oligosaccharides, water-soluble polysaccharides, compounds of general formula (P-I) or dimers or trimers of compounds of general formula (P-I):

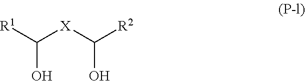

wherein X is

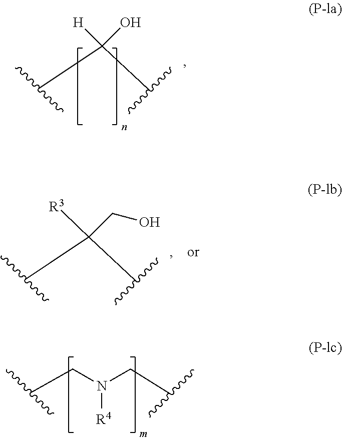

wherein
R¹ is —H, —CH₃;
R² is —H, —CH₃;
R³ is —CH₂OH, —NH₂;
R⁴ is —H, —(CH₂)ₚCH₂OH, —(CH₂)ₛCH(OH)CH₃;
m is an integer from 1 to 4;
n is an integer from 1 to 8;
p is an integer from 1 to 4;
s is an integer from 1 to 4;
(c) optionally, an extraneous alumina source;
(d) a sulfate source;
Wherein the composition comprises
(e) available aluminate, calculated as Al(OH)₄⁻, from the calcium aluminate mineral phases plus the optional extraneous aluminate source, per 100 g of cementitious binder a), in a total amount of at least 0.05 mol;
and the molar ratio of total available aluminate to sulfate is 0.4 to 2.0;
the composition further comprising
(f) an ettringite formation controller comprising (i) glyoxylic acid, a glyoxylic acid salt, a hydroxycarboxylic acid or derivative or salts thereof and/or a glyoxylic acid derivative and salts thereof; and/or mixtures of the aforementioned and (ii) a carbonate source, wherein the carbonate source is selected from inorganic carbonates, preferably having an aqueous solubility of 0.1 g·L⁻¹ or more at 25° C.; organic carbonates; and mixtures thereof.

The cementitious binder (a) comprises one or more calcium silicate mineral phases and one or more crystalline calcium aluminate mineral phases.

Conveniently, the mineralogical phases are herein indicated by their cement notation. The primary compounds are represented in the cement notation by the oxide varieties: C for CaO, M for MgO, S for SiO₂, A for Al₂O₃, $ for SO₃, F for Fe₂O₃, and H for H₂O.

In general, the calcium silicate mineral phases and calcium aluminate mineral phases constitute at least 90 wt.-% of the cementitious binder (a). Further, the calcium silicate mineral phases preferably constitute at least 60 wt.-% of the cementitious binder (a), more preferably at least 65 wt.-%, most preferably 65 to 75 wt.-%.

Suitably, the calcium silicate mineral phases are selected from C3S (alite) and C2S (belite). The calcium silicate mineral phases provide primarily final strength properties.

Suitably, the calcium aluminate mineral phases are selected from C3A, C4AF and C12A7, in particular C3A and C4AF.

In an embodiment, the cementitious binder (a) is Portland cement, in particular ordinary Portland cement (OPC). The term “Portland cement” denotes any cement compound containing Portland clinker, especially CEM I within the meaning of standard EN 197-1, paragraph 5.2. A preferred cement is ordinary Portland cement (OPC) according to DIN EN 197-1. The phases constituting Portland cement mainly are alite (C3S), belite (C2S), calcium aluminate (C3A), calcium ferroaluminate (C4AF) and other minor phases. Commercially available OPC may either contain calcium sulfate (<7 wt.-%) or is essentially free of calcium sulfate (<1 wt.-%).

Suitably, the cementitious binder (a) of the dry mortar composition has a Blaine surface area of at least 3800 cm²/g, preferably at least 4500 cm²/g, most preferably at least 5000 cm²/g. The Blaine surface area is used as parameter for grinding fineness. Finer milling allows for higher reactivity. The Blaine surface area may be determined according to DIN EN 196-6.

Suitably, the amount of cementitious binder (a) in the dry mortar composition is in the range of 8 to 50 wt.-%, preferably 10 to 30 wt.-%, relative to the solids content of the dry mortar composition.

Suitably, the binder (a) is present in an amount an amount of 180-900 kg/per m³, preferably, 180-600 kg/per m³, of the freshly mixed mortar composition.

According to the invention, the dry mortar composition contains (b) a salt of a polyol, wherein the polyol is selected from monosaccharides, oligosaccharides, water-soluble polysaccharides, compounds of general formula (P-I) or dimers or trimers of compounds of general formula (P-I):

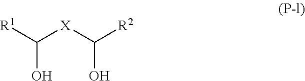

wherein X is

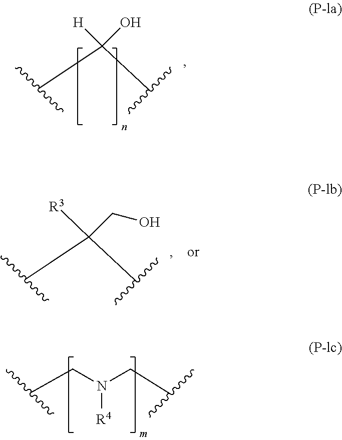

wherein
R¹ is —H, —CH₃;
R² is —H, —CH₃;
R³ is —CH₂OH, —NH₂;
R⁴ is —H, —(CH₂)ₚCH₂OH, —(CH₂)ₛCH(OH)CH₃;
m is an integer from 1 to 4;
n is an integer from 1 to 8;
p is an integer from 1 to 4;
s is an integer from 1 to 4.

When the dry mortar composition contains a metal salt of a polyol, especially a calcium salt of a polyol, a dry mortar composition having constant setting time while exhibiting a comparable comprehensive strength can be obtained.

The multivalent metal salt is selected from the group consisting of alkali metals, earth alkali metals, scandium, titanium, vanadium, chromium, manganese, iron, cobalt, nickel, copper, zinc and aluminum.

Earth alkali metal include beryllium, magnesium, calcium, strontium, barium. In a preferred embodiment, the earth alkali metal is calcium.

Alkali metals include lithium, sodium, potassium, rubidium, cesium and francium. “Polyol” is intended to denote a compound having at least two alcoholic hydroxyl groups in its molecule, for example 3, 4, 5 or 6 alcoholic hydroxyl groups. Polyols having vicinal hydroxyl groups are preferred. Polyols having at least three hydroxyl groups bound to three carbon atoms in sequence are most preferred.

In a preferred embodiment, the polyol (b) is selected from compounds consisting of carbon, hydrogen, and oxygen only and does not contain a carboxyl group (COOH) in its molecule.

In one embodiment, the polyol (b) is selected from saccharides. Useful saccharides include monosaccharides, such as glucose and fructose; disaccharides, such as lactose and sucrose; trisaccharides, such as raffinose; and water-soluble polysaccharides, such as amylose and maltodextrins. Monosaccharides and Disaccharides, in particular sucrose, are especially preferred.

In another preferred embodiment, the polyol (b) is selected from compounds consisting of carbon, hydrogen, and oxygen only and contains neither a carboxyl group (COOH) nor a carbonyl group (C═O) in its molecule. It is understood that the term “carbonyl group” encompasses the tautomeric form of the C═O group, i.e. a pair of doubly bonded carbon atoms adjacent to a hydroxyl group (—C═C(OH)—).

Compounds of formula (P-I) wherein X is (P-la) are generally referred to as sugar alcohols. Sugar alcohols are organic compounds, typically derived from sugars, containing one hydroxyl group (—OH) attached to each carbon atom. Useful sugar alcohols are mannitol, sorbitol, xylitol, arabitol, erythritol and glycerol. Among these, glycerol is particularly preferred. It is envisaged that carbonates of polyhydric alcohols such as glycerol carbonate can act as a polyol source. Compounds of formula (P-I) wherein X is (P-Ib) include pentaerythritol, and tris(hydroxymethyl)aminomethane.

Compounds of formula (P-I) wherein X is (P-Ic) include diethanolamine, triethanolamine triisopropanolamine, diisopropylamine, methyldiethanolamine and methyldiisopropanolamine.

Dimers or trimers denote compounds wherein two or three molecules of general formula (P-I) are linked via an ether bridge and which are formally derived from a condensation reaction with elimination of one or two molecules of water. Examples of dimers and trimers of compounds of formula (P-I) include dipentaerythritol and tripentaerythritol.

In a preferred embodiment, the calcium salt of the polyol (b) is a calcium salt of a compounds of general formula (P-I) or dimers or trimers of compounds of general formula (P-I), preferably a calcium salt of compounds of general formula (P-Ia), more preferably calcium glycerolate or the calcium salt of triethanolamine, and especially preferably calcium glycerolate.

In an embodiment, the metal salt of the polyol (b) is present in an amount of 0.15-2.5 wt.-%, preferably 0.3 to 2.5 wt.-% and more preferably 1.5 to 2.5 wt.-%, relative to the amount of the cementitious binder (a).

In an embodiment, the metal salt of the polyol (b) is present in a crystalline or amorphous form.

According to the invention, the dry mortar composition contains at least 0.05 of total available aluminate (e), calculated as Al(OH)₄⁻, from the calcium aluminate mineral phases plus the optional extraneous aluminate source, per 100 g of cementitious binder (a). Preferably, the dry mortar composition contains at least 0.065 mol, in particular at least 0.072 mol, of total available aluminate, per 100 g of cementitious binder (a).

When the dry mortar compositions contains at least 0.05 mol of total available aluminate per 100 g of cementitious binder (a) exhibit optimum performance regarding open time before setting and early strength development.

In an embodiment, the dry mortar composition contains not more than 0.2 mol of total available aluminate, calculated as AI (OH) 4′, from the calcium aluminate mineral phases plus the optional extraneous aluminate source, per 100 g of cementitious binder (a). Preferably, the dry mortar composition composition contains not more than 0.15 mol, in particular not more than 0.1 mol, of total available aluminate, per 100 g of cementitious binder (a). If the cementitious binder contains more than 0.2 mol of total available aluminate per 100 g of cementitious binder (a), open time is shorter.

Commonly, approximate proportions of the main minerals in Portland cement are calculated by the Bogue formula which in turn is based on the elemental composition of the clinker determined, e.g., by means of X-ray fluorescence (XRF). Such methods provide the oxide composition of the elements. This means that the amount of Al is reported as Al₂O₃. It has been found that cements with apparently the same Al₂O₃ content exhibit quite different properties regarding early strength and controllability by hydration control. Cement includes very different sources of Al of mineralogical nature and solubility. The present inventors have found that not all Al is available or accessible for the formation of ettringite. Only Al-containing mineral phases with adequate solubility in the aqueous environment of the cement paste participate in the formation of ettringite. Other Al-containing minerals such as crystalline aluminum oxides, e.g. corundum, do not generate aluminate in aqueous environments, due to their limited solubility. Consequently, elemental analysis alone cannot provide reliable values for available aluminate. Hence, the invention relies on the available aluminate (e), calculated as Al(OH)₄⁻. “Available aluminate” is meant to encompass mineral phases and Al-containing compounds that are capable of generating Al(OH)₄ in alkaline aqueous environments. Calcium aluminate phases, such as C3A (Ca₃Al₂O₆), dissolve in an alkaline aqueous environment to yield Al(OH)₄; and Ca₂₊ ions. For the purpose of this invention, the concentration of mineral phases and Al-containing compounds that are capable of generating Al(OH)₄ is expressed as mol of Al(OH)₄ per 100 g of cementitious binder (a).

It is believed that the common calcium aluminate mineral phases—in contrast to crystalline aluminum oxides—are sources of available aluminate. Therefore, the amount of available aluminate in a given cementitious binder may be determined by methods capable of discriminating between the mineral phases constituting the cementitious binder. A useful method for this purpose is Rietveld refinement of an X-ray diffraction (XRD) powder pattern. This software technique is used to refine a variety of parameters, including lattice parameters, peak position, intensities and shape. This allows theoretical diffraction patterns to be calculated. As soon as the calculated diffraction pattern is almost identical to the data of an examined sample, precise quantitative information on the contained mineral phases can be determined.

Generally, calcium aluminate mineral phases capable of generating Al(OH)₄⁻ in alkaline aqueous environments are tricalcium aluminate (C3A), monocalcium aluminate (CA), mayenite (C12A7), grossite (CA2), Q-phase (C20A 13M3S3) or tetracalcium aluminoferrite (C4AF). For practical purposes, if the cementitious binder (a) is Portland cement, it generally suffices to assess the following mineral phases only: tricalcium aluminate (C3A), monocalcium aluminate (CA), mayenite (C12A7) and tetracalcium aluminoferrite (C4AF), in particular tricalcium aluminate (C3A) and tetracalcium aluminoferrite (C4AF).

Alternatively, the amount of available aluminate may be obtained by determining the total amount of Al from the elemental composition of the cementitious binder (a), e.g., by XRF, and subtracting therefrom the amount of crystalline aluminum compounds not capable of generating available aluminate, as determined by XRD and Rietveld refinement. This method also takes into account amorphous, soluble aluminum compounds capable of generating available aluminate. Such crystalline aluminum compounds not capable of generating available aluminates include compounds of the melilite group, e.g., gehlenite (C2AS), compounds of the spinel group, e.g., spinel (MA), mullite (Al₂Al₂₊₂ₓSi₂₋₂ₓO₁₀₋ₓ), and corundum (Al₂O₃).

In one embodiment, the invention makes use of cementitious binders containing sufficient amounts of available aluminate from calcium aluminate mineral phases, as determined by, e.g., XRD analysis, to meet the amounts specified above.

Alternatively, if the cementitious binder (a) intrinsically contains an insufficient concentration of available aluminate per 100 g of cementitious binder (a), an extraneous aluminate source (c) can be added. Hence in some embodiments, the construction composition contains an extraneous aluminate source (c).

The extraneous aluminate source (c) provides available aluminate as defined above. Suitably, the extraneous aluminate source (c) is selected from non-calciferous aluminate sources, such as aluminum(III) salts, aluminum(III) complexes, crystalline aluminum hydroxide, amorphous aluminum hydroxide; and calciferous aluminate sources such as high alumina cement, sulfoaluminate cement or synthetic calcium aluminate mineral phases.

Useful aluminum(III) salts are aluminum(III) salts which readily form Al(OH)₄; in an alkaline aqueous environment. Suitable aluminum(III) salts include, but are not limited to, aluminum halides, such as aluminum(III) chloride, and their corresponding hydrates, amorphous aluminum oxides, aluminum hydroxides or mixed forms thereof, aluminum sulfates or sulfate-containing aluminum salts, such as potassium alum, and their corresponding hydrates, aluminum nitrate, aluminum nitrite and their corresponding hydrates, aluminum complexes such as aluminum triformate, aluminum triacetate, aluminum diacetate and aluminum monoacetate, aluminum containing metal organic frameworks, e.g. aluminum fumarate, e.g. Basollte™ A520, and M(II)-aluminum-oxo-hydrates, e.g. hydrogamnet. Aluminum(III) hydroxides may be crystalline or amorphous. Preferably, amorphous aluminum hydroxide is used.

High aluminate cement means a cement containing a high concentration of calcium aluminate phases, e.g., at least 30 wt.-%. More precisely, said mineralogical phase of aluminate type comprises tricalcium aluminate (C3A), monocalcium aluminate (CA), mayenite (C 12A7), tetracalcium aluminoferrite (C4AF), or a combination of several of these phases. Sulfoaluminate cement has a content of ye'elimite (of chemical formula 4CaO·3Al₂O₃·SO₃ or C4A3$ in cement notation) of typically greater than 15 wt.-%.

Suitable synthetic calcium aluminate mineral phases include amorphous mayenite (C12A7).

The dry mortar composition comprises a sulfate source (d). The sulfate source is a compound capable of providing sulfate ions in an alkaline aqueous environment. Generally, the sulfate source has an aqueous solubility of at least 0.6 mmol·L⁻¹ at a temperature of 30° C. The aqueous solubility of the sulfate source is suitably determined in water with a starting pH value of 7.

Specifically, the molar ratio of total available aluminate to sulfate is in the range of 0.4 to 2.0, preferably 0.57 to 0.8, in particular about 0.67. This means that the mixing ratios in the composition are adjusted so that the highest possible proportion of ettringite is formed from the available aluminate.

As mentioned earlier, Portland cement in its commercially available form typically contains small amounts of a sulfate source. If the intrinsic amount of sulfate is unknown, it can be determined by methods familiar to the skilled person such as elemental analysis by XRF. As the sulfate source commonly used in the cement production, alkaline earth metal sulfates, alkali metal sulfates, or mixed forms thereof, such as gypsum, hemihydrate, anhydrite, arkanite, thenardite, syngenite, langbeinite, are typically crystalline, the amount thereof can also be determined by XRD. Both the intrinsic amount of sulfate and any added extraneous sulfate source are considered in the calculation of the molar ratio of total available aluminate to sulfate.

In general, the extraneous sulfate source may be a calcium sulfate source, preferably selected from calcium sulfate dihydrate, anhydrite, a- and B-hemihydrate, i.e. a-bassanite and β-bassanite, or mixtures thereof. Preferably the calcium sulfate source is a-bassanite and/or β-bassanite. Other sulfate sources are alkali metal sulfates like potassium sulfate or sodium sulfate.

It is envisaged that an additive can act as a source of both aluminate and sulfate, such as aluminum sulfate hexadecahydrate or aluminum sulfate octadecahydrate.

In one embodiment, the sulfate source (d) is a calcium sulfate source, preferably calcium sulfate anhydride. The calcium sulfate source is generally comprised in an amount of 3 to 20 wt.-%, preferably 10 to 15 wt.-%, relative to the amount of cementitious binder (a).

According to the invention, the dry mortar composition contains an ettringite formation controller (f). The ettringite formation controller comprises (i) glyoxylic acid, a glyoxylic acid salt, a hydroxycarboxylic acid or derivative or salts thereof and/or a glyoxylic acid derivative and salts thereof; and/or mixtures of the aforementioned; and a carbonate source. The carbonate source is selected from inorganic carbonates, preferably having an aqueous solubility of 0.1 g·L⁻¹ or more; organic carbonates; and mixtures thereof.

It is believed that the component (i), i.e., glyoxylic acid, a glyoxylic acid salt and/or a glyoxylic acid derivative a glyoxylic acid salt, a hydroxycarboxylic acid or derivative or salts thereof and/or a glyoxylic acid derivative and salts thereof; and/or mixtures of the aforementioned, in combination with carbonate ions, retard the formation of ettringite from the aluminate phases originating from the cementitious binder.

Preferably, the (i) glyoxylic acid, a glyoxylic acid salt and/or a glyoxylic acid derivative a glyoxylic acid salt, a hydroxycarboxylic acid or derivative or salts thereof and/or a glyoxylic acid derivative and salts thereof; and/or mixtures of the aforementioned is present in a total amount of 0.2 to 2 wt.-%, preferably 0.3 to 1 wt.-%, relative to the amount of cementitious binder (a).

Useful glyoxylic acid salts include alkali metal glyoxylates, e.g., sodium glyoxylate and potassium glyoxylate.

Useful glyoxylic acid derivatives include glyoxylic acid polymers and glyoxylic acid adducts.

In an embodiment, the glyoxylic acid polymer is an amine-glyoxylic acid condensate. The term “amine-glyoxylic acid condensate” is intended to mean a condensate of glyoxylic acid with a compound containing amino or amido groups reactive with aldehydes. Examples of compounds containing aldehyde-reactive amino or amido groups include urea, thiourea, melamine, guanidine, acetoguanamine, benzoguanamine and other acylguanamines and polyacrylamide.

Preferably, the amine-glyoxylic acid condensate is a melamine-glyoxylic acid condensate, a urea-glyoxylic acid condensate, a melamine-urea-glyoxylic acid condensate and/or a polyacrylamide-glyoxylic acid condensate. Urea-glyoxylic acid condensates are particularly preferred. Useful amine-glyoxylic acid condensates and their manufacture are described in WO 2019/077050, incorporated by reference herein.

The amine-glyoxylic acid condensates are obtainable by reacting glyoxylic acid with a compound containing aldehyde-reactive amino or amido groups. The glyoxylic acid can be used as an aqueous solution or as glyoxylic acid salts, preferably glyoxylic acid alkali metal salts. Likewise, the amine compound can be used as salt, for example as guanidinium salts.

In general, the amine compound and the glyoxylic acid are reacted in a molar ratio of 0.5 to 2 equivalents, preferably 1 to 1.3 equivalents, of glyoxylic acid per aldehyde-reactive amino or amido group. The reaction is carried out at a temperature of 0 to 120° C., preferably 25 to 105° C. The pH value is preferably from 0 to 8. The viscous products obtained in the reaction can be used as such, adjusted to a desired solids content by dilution or concentration or evaporated to dryness by, e.g., spray-drying, drum-drying, or flash-drying.

In general, the amine-glyoxylic acid condensates have molecular weights in the range of from 500 to 25 000 g/mol, preferably 1000 to 10 000 g/mol, particularly preferred 1000 to 5000 g/mol.

A useful glyoxylic acid adduct is a glyoxylic acid bisulfite adduct of formula

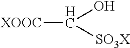

wherein

X is, independently of one another, selected from H or a cation equivalent Catₐ wherein Cat is a cation not especially limited, but preferably selected from an alkali metal, alkaline earth metal, zinc, iron, ammonium, or phosphonium cation, or mixtures thereof and a is 1/n wherein n is the valence of the cation. The glyoxylic acid bisulfite adduct can be prepared as described in WO 2017/212045.

Suitable hydroxycarboxylic acid or derivative or salts thereof include x-hydroxy monocarboxylic acids or salts thereof.

Suitable α-hydroxy monocarboxylic acids or salts thereof include citric acid, tartaric acid, lactic acid, malic acid, glycolic acid, gluconic acid, and their salts and mixtures thereof. Sodium gluconate is particularly preferred.

The carbonate source (ii) may be an inorganic carbonate preferably having an aqueous solubility of 0.1 g−L⁻¹ or more at 25° C. The aqueous solubility of the inorganic carbonate is suitably determined in water with a starting pH value of 7. It is understood that the pH value at the solubility limit is higher than the starting pH value.

The presence of the carbonate source ensures that the mixing water is initially highly concentrated in carbonate ions. Carbonate ions are believed to adsorb onto mineral phase surfaces along with glyoxylic acid, glyoxylic acid salts and glyoxylic acid derivatives.

Preferably, the carbonate source is present in an amount of 0.3 to 1 wt.-%, preferably 0.3 to 0.5 wt.-%, relative to the amount of cementitious binder (a).

The carbonate source may be an inorganic carbonate preferably having an aqueous solubility of 0.1 g−L⁻¹ or more.

The “inorganic carbonate” is intended to mean a salt of carbonic acid, i.e., a salt which is characterized by the presence of a carbonate ion (CO₃²⁻) and/or hydrogen carbonate ion (HCO).

In an embodiment, the inorganic carbonate may be suitably selected from alkali metal carbonates such as potassium carbonate, sodium carbonate, sodium bicarbonate, or lithium carbonate, and alkaline earth metal carbonates satisfying the required aqueous solubility, such as magnesium carbonate. Further suitable inorganic carbonates include carbonates of nitrogenous bases such as guanidinium carbonate und ammonium carbonate. Sodium carbonate and sodium bicarbonate are especially preferred, in particular sodium bicarbonate.

Alternatively, the carbonate source is selected from organic carbonates. “Organic carbonate” denotes an ester of carbonic acid. The organic carbonate is hydrolyzed in the presence of the cementitious system to release carbonate ions. In an embodiment, the organic carbonate is selected from ethylene carbonate, propylene carbonate, glycerol carbonate, dimethyl carbonate, di(hydroxyethyl)carbonate or a mixture thereof, preferably ethylene carbonate, propylene carbonate, and glycerol carbonate or a mixture thereof, and in particular ethylene carbonate and/or propylene carbonate. Mixtures of inorganic carbonates and organic carbonates can as well be used.

The weight ratio of component (i) to component (ii) is typically in the range of about 10:1 to about 1:10, preferably about 5:1 to about 1:5 or about 1:1 to about 1:4.

Preferably, the dry mortar composition of the invention comprises a co-retarder (g) selected from (g-1) phosphonic acids and salts thereof, (g-2) polycarboxylic acids and salts thereof, and mixtures thereof.

Preferably, the co-retarder (g) is present in a total amount of 0.05 to 1wt.-%, preferably 0.05 to 0.2 wt.-%, relative to the amount of cementitious binder (a).

Suitable phosphonic acids and salts thereof (g-1) are in particular polyphosphonic acids and salts thereof and include 1-hydroxyethylidene-1,1-diphosphonic acid (HEDP), amino-tris(methylenephosphonic acid) (ATMP) or [[(2-hydroxyethyl)imino]bis(methylene)]-bisphosphonic acid, and their salts and mixtures thereof. The respective chemical formulae of the preferred di- or triphosphonates are given in the following:

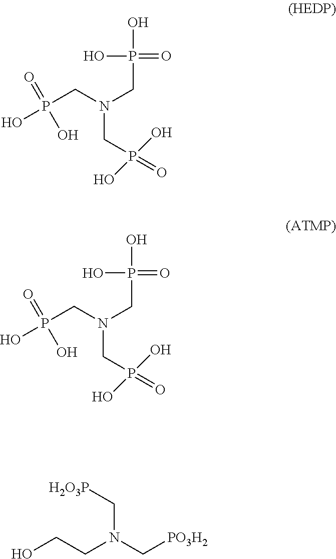

### [[2-hydroxyethyl)imino]bis(methylene)]bisphosphonic acid

Suitable polycarboxylic acids and salts thereof (g-2) include phosphonoalkyl carboxylic acids, amino carboxylic acids, and polymeric carboxylic acids, and their salts and mixtures thereof.

By the term polycarboxylic acid, as used herein, is meant a compound or polymer having two or more carboxyl groups to the molecule.

Suitable polycarboxylic acids include low molecular weight polycarboxylic acids (having a molecular weight of, e.g., 500 or lower), in particular aliphatic polycarboxylic acids, such as oxalic acid, malonic acid, succinic acid, glutaric acid, adipic acid, pimelic acid, fumaric acid, maleic acid, itaconic acid, citraconic acid, mesaconic acid, malic acid, tartaric acid, and citric acid.

Suitable phosphonoalkyl carboxylic acids include 1-phosphonobutane-1,2,4-tricarboxylic acid, 2-phosphonobutane-1,2,4-tricarboxylic acid, 3-phosphonobutane-1,2,4-tricarboxylic acid, 4-phosphonobutane-1,2,4-tricarboxylic acid, 2,4-diphosphonobutane-1,2,4-tricarboxylic acid, 2-phosphonobutane-1,2,3,4-tetracarboxylic acid, 1-methyl-2-phosphonopentane-1,2,4-tricarboxylic acid, or 1,2-phosphonoethane-2-dicarboxylic acid.

Suitable amino carboxylic acids include ethylenediamine tetra acetic acid, or nitrilotriacetic acid.

Suitable polymeric carboxylic acids include homopolymers of acrylic acid, homopolymers of methacrylic acid, polymaleic acid, copolymers such as ethylene/acrylic acid copolymer and ethylene/methacrylic acid copolymer; copolymers of acrylic acid and/or methacrylic acid with sulfo or sulfonate group containing monomers. In an embodiment, the sulfo or sulfonate group containing monomers are selected from the group of vinylsulfonic acid, (meth)allylsulfonic acid, 4-vinylphenylsulfonic acid or 2-acrylamido-2-methylpropylsulfonic acid (ATBS), with ATBS being particularly preferred. It is possible that one more of the before mentioned sulfo or sulfonate group containing monomers are contained in the copolymers.

In general, the molecular weight of the polymeric carboxylic acids is in the range of from 1000 to 30000 g/mol, preferably 1000 to 10 000 g/mol. The molecular weight is measured by the gel permeation chromatography method (GPC) as indicated in detail in the experimental part.

Suitably, the polymeric carboxylic acid or salt thereof has a milliequivalent number of carboxyl groups of 3.0 meq/g or higher, preferably 3.0 to 17.0 meq/g, more preferably 5.0 to 17.0 meq/g, most preferably 5.0 to 14.0 meq/g, assuming all the carboxyl groups to be in unneutralized form.

Preferably, the dry mortar composition according to the invention additionally comprises a fine material (h) having a Dv90 of less than 200 μm, preferably less than 150 μm, more preferably less than 70 μm, or less than 50 μm.

The DV90 (by volume) corresponds to theo 90^{th} percentile of the particle size distribution, meaning that 90% of the particles have a size of the Dv90 or smaller and 10% have a size larger than the Dv90. Generally, the Dv90 and other values of the same type are characteristic of the granulometric profile (volume distribution) of a collection of particles or grains. Conformity with the requirement that 90% of the particles have a size of 200 μm or less is ensured if at least 90% by volume of the particles pass a sieve having a mesh opening of 200 μm. Alternatively, the Dv90 may be calculated from a particle size distribution measured by static laser diffraction using a Malvern Mastersizer 2000.

The particle size distribution influences the packing density, which in turn influences water requirement and mechanical properties of the dry mortar composition. The packing density of the dry mortar composition and in particular of the fine material should be as high as possible to improve workability and reduce water demand. Generally, the grain size of the fine material (h) ranges from 50 nm to 1 mm.

The dry mortar composition comprises a fine material (h) having a Dv90 of less than 200 μm, preferably less than 175 μm, more preferably less than 150 μm, selected from alkali-activatable binders, rock powders and inorganic pigments, or mixtures thereof, in a total amount of 20 to 200 parts by weight, relative to 100 parts by weight of cementitious binder (a).

The term “alkali-activatable binder” is meant to designate materials which in an aqueous alkaline environment set in a cement-like fashion. The term encompasses materials that are commonly referred to as “latent hydraulic binders” and “pozzolanic binders”.

For the purposes of the present invention, a “latent hydraulic binder” is preferably a binder in which the molar ratio (CaO+MgO):SiO₂ is from 0.8 to 2.5 and particularly from 1.0 to 2.0. In general terms, the above-mentioned latent hydraulic binders can be selected from industrial and/or synthetic slag, in particular from blast furnace slag, electrothermal phosphorous slag, steel slag and mixtures thereof. The “pozzolanic binders” can generally be selected from amorphous silica, preferably precipitated silica, fumed silica and microsilica, ground glass, metakaolin, aluminosilicates, fly ash, preferably brown-coal fly ash and hard-coal fly ash, natural pozzolans such as tuff, trass and volcanic ash, calcined clays, burnt shale, rice husk ash, natural and synthetic zeolites and mixtures thereof.

The slag can be either industrial slag, i.e. waste products from industrial processes, or else synthetic slag. The latter can be advantageous because industrial slag is not always available in consistent quantity and quality.

Blast furnace slag (BFS) is a waste product of the blast furnace process. Other materials are granulated blast furnace slag (GBFS) and ground granulated blast furnace slag (GGBFS), which is granulated blast furnace slag that has been finely pulverized. Ground granulated blast furnace slag varies in terms of grinding fineness and grain size distribution, which depend on origin and treatment method, and grinding fineness influences reactivity here.

For the purposes of the present invention, the expression “blast furnace slag” is however intended to comprise materials resulting from all of the levels of treatment, milling, and quality mentioned (i.e. BFS, GBFS and GGBFS). Blast furnace slag generally comprises from 30 to 45% by weight of CaO, about 4 to 17% by weight of MgO, about 30 to 45% by weight of SiO₂, and about 5 to 15% by weight of Al₂O₃, typically about 40% by weight of CaO, about 10% by weight of MgO, about 35% by weight of SiO₂ and about 12% by weight of Al2O3.

Electrothermal phosphorous slag is a waste product of electrothermal phosphorous production. It is less reactive than blast furnace slag and comprises about 45 to 50% by weight of CaO, about 0.5 to 3% by weight of MgO, about 38 to 43% by weight of SiO₂, about 2 to 5% by weight of Al₂O₃ and about 0.2 to 3% by weight of Fe₂O₃, and also fluoride and phosphate. Steel slag is a waste product of various steel production processes with greatly varying composition.

Amorphous silica is preferably an X ray-amorphous silica, i.e. a silica for which the powder diffraction method reveals no crystallinity. The content of SiO₂ in the amorphous silica of the invention is advantageously at least 80% by weight, preferably at least 90% by weight.

Precipitated silica is obtained on an industrial scale by way of precipitating processes starting from water glass. Precipitated silica from some production processes is also called silica gel. Fumed silica is produced via reaction of chlorosilanes, for example silicon tetrachloride, in ahydrogen/oxygen flame. Fumed silica is an amorphous SiO₂ powder of particle diameter from 5 to 50 nm with specific surface area of from 50 to 600 m² g⁻¹.

Microsilica is a by-product of silicon production or ferrosilicon production, and likewise consists mostly of amorphous SiO₂ powder. The particles have diameters of the order of magnitude of 0.1 μm. Specific surface area is of the order of magnitude of from 15 to 30 m²·g⁻¹.

Metakaolin is produced when kaolin is dehydrated. Whereas at from 100 to 200° C. kaolin releases physically bound water, at from 500 to 800° C. a dehydroxylation takes place, with collapse of the lattice structure and formation of metakaolin (Al₂Si₂O₇). Accordingly pure metakaolin comprises about 54% by weight of SiO₂, and about 46% by weight of Al₂O₃. Fly ash is produced inter alia during the combustion of coal in power stations. Class C fly ash (brown-coal fly ash) comprises according to WO 08/012438 about 10% by weight of CaO, whereas class F fly ash (hard-coal fly ash) comprises less than 8% by weight, preferably less than 4% by weight, and typically about 2% by weight of CaO.

In another embodiment, the fine material (h) is selected from “rock powders”. Rock powders consist of finely crushed rock and are abundantly available. Their use does not contribute significantly to the carbon footprint. Generally, rock powders include silicate or carbonate rock powder. Useful examples include limestone, such as ground limestone or precipitated limestone, dolomite, basalt, and quartz powder.

In another embodiment, the fine material (h) is selected from an inorganic pigment. Suitable inorganic pigments include iron oxides, titanium dioxide, cobalt-chrome-aluminum-spinels, and chrome(III)-oxides such as chrome green. Preferably, inorganic pigments do not constitute 20 more than 5 wt.-%, preferably not more than 3 wt.-%, of the total amount of cementitious binder (a) and fine material (h), with the remainder of the fine material (h) being alkali-activated binders and/or rock powders.

Although not preferred, the dry mortar composition may comprise setting accelerators as conventionally used, e.g., in repair mortars and self-levelling underlayments, such as lithium salts, in particular lithium carbonate or lithium sulfate. It is an advantageous feature of the invention that the early strength development of the dry mortar composition is such that lithium setting accelerators can be dispensed with. Hence, in preferred embodiments, the dry mortar composition does not contain a lithium setting accelerator. This also serves to reduce the cost of the dry mortar composition, as lithium setting accelerators are quite costly ingredients.

Preferably, the dry mortar composition according to the invention additionally comprises at least one dispersant for inorganic binders, especially a dispersant for cementitious mixtures like concrete or mortar.

Examples of useful dispersants include
comb polymers having a carbon-containing backbone to which are attached pendant cement-anchoring groups and polyether side chains,
non-ionic comb polymers having a carbon-containing backbone to which are attached pendant hydrolysable groups and polyether side chains, the hydrolysable groups upon hydrolysis releasing cement-anchoring groups,
colloidally disperse preparations of polyvalent metal cations, such as Al³⁺, Fe³⁺ or Fe²⁺, and a polymeric dispersant which comprises anionic and/or anionogenic groups and polyether side chains, and the polyvalent metal cation is present in a superstoichiometric quantity, calculated as cation equivalents, based on the sum of the anionic and anionogenic groups of the polymeric dispersant,
sulfonated melamine-formaldehyde condensates,
lignosulfonates,
sulfonated ketone-formaldehyde condensates,
sulfonated naphthalene-formaldehyde condensates,
phosphonate containing dispersants,
phosphate containing dispersants, and
mixtures thereof.

Preferably, the dispersant is present in a total amount of 0.06 to 0.4 wt.-%, preferably 0.09 to 0.3 wt.-%, relative to the amount of cementitious binder (a).

Comb polymers having a carbon-containing backbone to which are attached pendant cement-anchoring groups and polyether side chains are particularly preferred. The cement-anchoring groups are anionic and/or anionogenic groups such as carboxylic groups, phosphonic or phosphoric acid groups or their anions. Anionogenic groups are the acid groups present in the polymeric dispersant, which can be transformed to the respective anionic group under alkaline conditions.

Preferably, the structural unit comprising anionic and/or anionogenic groups is one of the general formulae (Ia), (Ib), (Ic) and/or (Id):

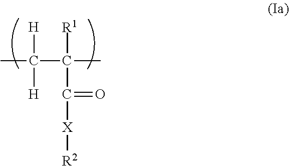

wherein
R¹ is H, C₁-C₄ alkyl group, CH₂COOH or CH₂CO—X—R^{3A}, preferably H or methyl;
X is NH—(CₙH₂ₙ), O(CₙH₂ₙ) with n=1, 2, 3 or 4, where the nitrogen atom or the oxygen atom is bonded to the CO group;
R² is OM, PO₃M₂, or O—PO₃M₂, with the proviso that X is a chemical bond if R² is OM;
R is PO₃M₂, or O—PO₃M₂;

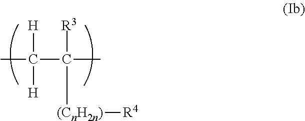

wherein
R³ is H or C₁-C₄ alkyl, preferably H or methyl;
n is 0, 1, 2, 3 or 4;
R⁴ is PO₃M₂, or O—PO₃M₂;

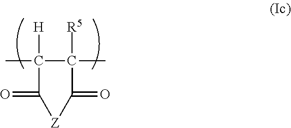

wherein
R⁵ is H or C₁-C₄ alkyl, preferably H;
Z is O or NR₇;
R⁷ is H, (CₙH₂ₙ)—OH, (CₙH₂ₙ)—PO₃M₂, (CₙH₂ₙ)—OPO₃M₂, (C₆H₄)—PO₃M₂, or (C₆H₄)—OPO₃M₂, and
n is 1, 2, 3 or 4;

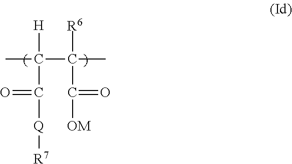

wherein
R⁶ is H or C, —C, alkyl, preferably H;
Q is NR⁷ or O;
R⁷ is H, (CₙH₂ₙ)—OH, (CₙH₂ₙ)—PO₃M₂, (CₙH₂ₙ)—OPO₃M₂, (CH₄)—PO₃M₂, or (C₆H₄)—OPO₃M₂,
n is 1, 2, 3 or 4; and
   where each M independently is H or a cation equivalent.

Preferably, the structural unit comprising a polyether side chain is one of the general formulae (IIa), (IIb), (IIc) and/or (IId):

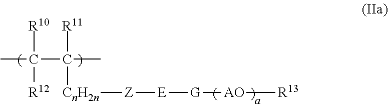

wherein
R10, R11 and R12 independently of one another are H or C1-C4 alkyl, preferably H or methyl;
Z is o or S;
E is C₂-C₆ alkylene, cyclohexylene, CH₂-C₆H₁₀, 1,2-phenylene, 1,3-phenylene or 1,4-phenylene;
G is O, NH or CO—NH; or
E and G together are a chemical bond;
A is C₂-C₅ alkylene or CH₂CH (C₆H₅), preferably C₂-C₃ alkylene;
n is 0, 1, 2, 3, 4 or 5;
a is an integer from 2 to 350, preferably 10 to 150, more preferably 20 to 100;
R¹³ is H, an unbranched or branched C₁-C₄ alkyl group, CO—NH₂ or COCH₃;

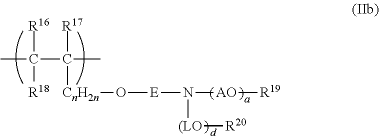

wherein
R¹⁶, R¹⁷ and R¹⁸ independently of one another are H or C₁-C₄ alkyl, preferably H;
E is C₂-C₆ alkylene, cyclohexylene, CH₂—C₆H₁₀, 1,2-phenylene, 1,3-phenylene, or 1,4-phenylene,
   or is a chemical bond;
A is C₂-C₅ alkylene or CH₂CH(C₆H₅), preferably C₂-C₃ alkylene;
n is 0, 1, 2, 3, 4 or 5;
L is C₂-C₅ alkylene or CH₂CH(C₆H₅), preferably C₂-C₃ alkylene;
a is an integer from 2 to 350, preferably 10 to 150, more preferably 20 to 100;
d is an integer from 1 to 350, preferably 10 to 150, more preferably 20 to 100;
R¹⁹ is H or C₁-C₄ alky; and
R²⁰ is H or C₁-C₄ alkyl;

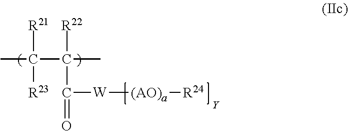

wherein
R²¹, R²² and R²³ independently are H or C₁-C₄ alkyl, preferably H;
W is 0, NR²⁵, or is N;
Y is 1 if W═O or NR²⁵, and is 2 if W═N;
A is C₂-C₅ alkylene or CH₂CH(C₆H₅), preferably C₂-C₃ alkylene;
a is an integer from 2 to 350, preferably 10 to 150, more preferably 20 to 100;
R²⁴ is H or C₁-C₄ alkyl;
R²⁵ is H or C₁-C₄ alkyl;

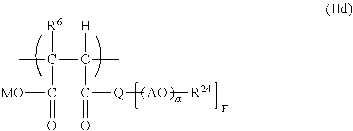

wherein
R⁶ is H or C₁-C₄ alkyl, preferably H;
Q is NR¹⁰, N or O;
Y is 1 if Q=O or NR¹⁰ and is 2 if Q=N;
R¹⁰ is H or C₁-C₄ alkyl;
A is C₂-C₅ alkylene or CH₂CH (C₆H₅), preferably C₂-C₃ alkylene; and
a is an integer from 2 to 350, preferably 10 to 150, more preferably 20 to 100;
   where each M independently is H or a cation equivalent.

The molar ratio of structural units (1) to structural units (11) varies from 1:3 to about 10:1, preferably 1:1 to 10:1, more preferably 3:1 to 6:1. The polymeric dispersants comprising structural units (I) and (II) can be prepared by conventional methods, for example by free radical polymerization or controlled radical polymerization. The preparation of the dispersants is, for example, described in EP 0 894 811, EP 1 851 256, EP 2 463 314, and EP 0 753 488.

A number of useful dispersants contain carboxyl groups, salts thereof or hydrolysable groups releasing carboxyl groups upon hydrolysis. Preferably, the milliequivalent number of carboxyl groups contained in these dispersants (or of carboxyl groups releasable upon hydrolysis of hydrolysable groups contained in the dispersant) is lower than 3.0 meq/g, assuming all the carboxyl groups to be in unneutralized form.

More preferably, the dispersant is selected from the group of polycarboxylate ethers (PCEs). In PCEs, the anionic groups are carboxylic groups and/or carboxylate groups. The PCE is preferably obtainable by radical copolymerization of a polyether macromonomer and a monomer comprising anionic and/or anionogenic groups. Preferably, at least 45 mol-%, preferably at least 80 mol-% of all structural units constituting the copolymer are structural units of the polyether macromonomer or the monomer comprising anionic and/or anionogenic groups.

A further class of suitable comb polymers having a carbon-containing backbone to which are attached pendant cement-anchoring groups and polyether side chains comprise structural units (III) and (IV):

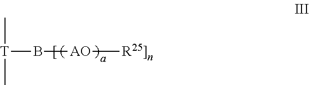

wherein
T is phenyl, naphthyl or heteroaryl having 5 to 10 ring atoms, of which 1 or 2 atoms are heteroatoms selected from N, O and S;
n is 1 or 2;
B is N, NH or O, with the proviso that n is 2 if B is N and n is 1 if B is NH or O;
A is C₂-C₅ alkylene or CH₂CH(C₆H₅), preferably C₂-C₃ alkylene;
a is an integer from 1 to 300;
R²⁵ is H, C₁-C₁₀ alky, C₅-C₈ cycloalkyl, aryl, or heteroaryl having 5 to 10 ring atoms, of which 1 or 2 atoms are heteroatoms selected from N, O and S;
   where the structural unit (IV) is selected from the structural units (IVa) and (IVb):

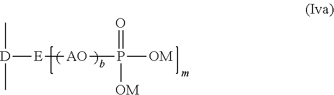

wherein
D is phenyl, naphthyl or heteroaryl having 5 to 10 ring atoms, of which 1 or 2 atoms are heteroatoms selected from N, O and S;
E is N, NH or O, with the proviso that m is 2 if E is N and m is 1 if E is NH or O;
A is C₂-C₅ alkylene or CH₂CH(C₆H₅), preferably C₂-C₃ alkylene;
b is an integer from 0 to 300;
M independently is H or a cation equivalent;

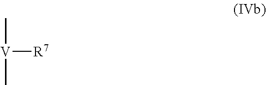

wherein
V is phenyl or naphthyl and is optionally substituted by 1 or two radicals selected from R⁸, OH, OR⁸, (CO)R⁸, COOM, COOR⁸, SO₃R⁸ and NO2;
R⁷ is COOM, OCH₂COOM, SO₃M or OPO₃M₂;
M is H or a cation equivalent; and
R⁸ is C₁-C₄, alkyl, phenyl, naphthyl, phenyl-C₁-C₄ alkyl or C₁-C₄ alkylphenyl.

Polymers comprising structural units (III) and (IV) are obtainable by polycondensation of an aromatic or heteroaromatic compound having a polyoxyalkylene group attached to the aromatic or heteroaromatic core, an aromatic compound having a carboxylic, sulfonic or phosphate moiety, and an aldehyde compound such as formaldehyde.

In an embodiment, the dispersant is a non-ionic comb polymer having a carbon-containing backbone to which are attached pendant hydrolysable groups and polyether side chains, the hydrolysable groups upon hydrolysis releasing cement-anchoring groups. Conveniently, the structural unit comprising a polyether side chain is one of the general formulae (IIa), (IIb), (IIc) and/or (IId) discussed above. The structural unit having pendant hydrolysable groups is preferably derived from acrylic acid ester monomers, more preferably hydroxyalkyl acrylic monoesters and/or hydroxyalkyl diesters, most preferably hydroxypropyl acrylate and/or hydroxyethyl acrylate. The ester functionality will hydrolyze to (deprotonated) acid groups upon exposure to water at preferably alkaline pH, which is provided by mixing the cementitious binder with water, and the resulting acid functional groups will then form complexes with the cement component.

In one embodiment, the dispersant is selected from colloidally disperse preparations of polyvalent metal cations, such as Al³⁺, Fe³⁺ or Fe²⁺, and a polymeric dispersant which comprises anionic and/or anionogenic groups and polyether side chains. The polyvalent metal cation is present in a superstoichiometric quantity, calculated as cation equivalents, based on the sum of the anionic and anionogenic groups of the polymeric dispersant. Such dispersants are described in further detail in WO 2014/013077 A1, which is incorporated by reference herein.

Suitable sulfonated melamine-formaldehyde condensates are of the kind frequently used as plasticizers for hydraulic binders (also referred to as MFS resins). Sulfonated melamine-formaldehyde condensates and their preparation are described in, for example, CA 2172 004 35 A1, DE 44 1 1 797 A1, U.S. Pat. Nos. 4,430,469, 6,555,683 and CH 686 186 and also in Ullmann's Encyclopedia of Industrial Chemistry, 5th Ed., vol. A2, page 131, and Concrete Admixtures Handbook-Properties, Science and Technology, 2. Ed., pages 411,412. Preferred sulfonated melamine-formaldehyde condensates encompass (greatly simplified and idealized) units of the formula

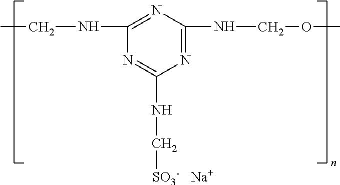

in which n stands generally for 10 to 300. The molar weight is situated preferably in the range from 2500 to 80 000. Additionally, to the sulfonated melamine units it is possible for other monomers to be incorporated by condensation. Particularly suitable is urea. Moreover, further aromatic units as well may be incorporated by condensation, such as gallic acid, aminobenzenesulfonic acid, sulfanilic acid, phenolsulfonic acid, aniline, ammoniobenzoic acid, dialkoxybenzenesulfonic acid, dialkoxybenzoic acid, pyridine, pyridinemonosulfonic acid, pyridinedisulfonic acid, pyridinecarboxylic acid and pyridinedicarboxylic acid. An example of melaminesulfonate-formaldehyde condensates are the Melment® products distributed by Master Builders Solutions Deutschland GmbH.

Suitable lignosulfonates are products which are obtained as by-products in the paper industry. They are described in Ullmann's Encyclopedia of Industrial Chemistry, 5th Ed., vol. A8, pages 586, 587. They include units of the highly simplified and idealizing formula

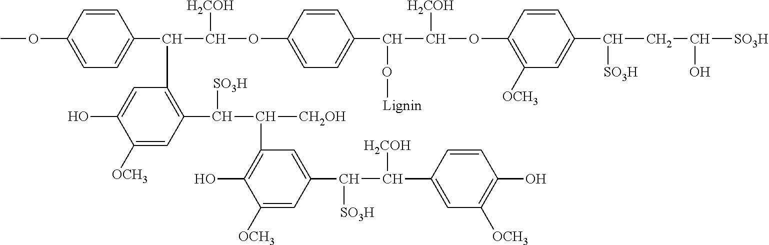

Lignosulfonates have molar weights of between 2000 and 100 000 g/mol. In general, they are present in the form of their sodium, calcium and/or magnesium salts. Examples of suitable lignosulfonates are the Borresperse products distributed by Borregaard LignoTech, Norway.

Suitable sulfonated ketone-formaldehyde condensates are products incorporating a monoketone or diketone as ketone component, preferably acetone, butanone, pentanone, hexanone or cyclohexanone. Condensates of this kind are known and are described in WO 2009/103579, for example. Sulfonated acetone-formaldehyde condensates are preferred. They generally comprise units of the formula (according to J. Plank et al., J. Appl. Poly. Sci. 2009, 2018-2024):

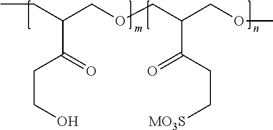

where m and n are generally each 10 to 250, M is an alkali metal ion, such as Na, and the ratio min is in general in the range from about 3:1 to about 1:3, more particularly about 1.2:1 to 1:1.2. Furthermore, it is also possible for other aromatic units to be incorporated by condensation, such as gallic acid, aminobenzenesulfonic acid, sulfanilic acid, phenolsulfonic acid, aniline, ammoniobenzoic acid, dialkoxybenzenesulfonic acid, dialkoxybenzoic acid, pyridine, pyridinemonosulfonic acid, pyridinedisulfonic acid, pyridinecarboxylic acid an pyridinedicarboxylic acid. Examples of suitable sulfonated acetone-formaldehyde condensates are the Melcret K1 L products distributed by Master Builders Solutions Deutschland GmbH.

Suitable sulfonated naphthalene-formaldehyde condensates are products obtained by sulfonation of naphthalene and subsequent polycondensation with formaldehyde. They are described in references including Concrete Admixtures Handbook—Properties, Science and Technology, 2. Ed., pages 411-413 and in Ullmann's Encyclopedia of Industrial Chemistry, 5th Ed., vol. AB, pages 587, 588. They comprise units of the formula

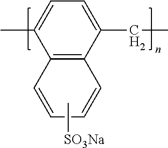

Typically, molar weights (Mw) of between 1000 and 50 000 g/mol are obtained. Furthermore, it is also possible for other aromatic units to be incorporated by condensation, such as gallic acid, aminobenzenesulfonic acid, sulfanilic acid, phenolsulfonic acid, aniline, ammoniobenzoic acid, dialkoxybenzenesulfonic acid, dialkoxybenzoic acid, pyridine, pyridinemonosulfonic acid, pyridinedisulfonic acid, pyridinecarboxylic acid and pyridinedicarboxylic acid. Examples of suitable sulfonated β-naphthalene-formaldehyde condensates are the Melcret 500 L products distributed by Master Builders Solutions Deutschland GmbH.

Generally, phosphonate containing dispersants incorporate phosphonate groups and polyether side groups.

Suitable phosphonate containing dispersants are those according to the following formula

R—(OA²)ₙ₆—N—[CH₂—PO(OM³₂)₂]₂

wherein
R is Hora hydrocarbon residue, preferably a C₁-C₁₅ alkyl radical,
A² is independently C₂-C₁₈ alkylene, preferably ethylene and/or propylene, most preferably ethylene,
N6 is an integer from 5 to 500, preferably 10 to 200, most preferably 10 to 100, and
M³ is H, an alkali metal, 1/2 alkaline earth metal and/or an amine.

The dry mortar construction composition may additionally comprise at least one aggregate.

The term “aggregate” is understood to relate to a filler material, i.e. an inert material which essentially does not form hydration products. The aggregate may be selected from quartz, sand, marble, e.g., crushed marble, glass spheres, granite, basalt, limestone, sandstone, calcite, marble, serpentine, travertine, dolomite, feldspar, gneiss, alluvial sands, and mixtures thereof. The packing density of the aggregates should be as high as possible and their particle size distribution ideally constitutes a fuller type sieve curve.

Aggregates may be classified by particle size. Fine aggregates, e.g., sand, generally have a diameter distribution of 150 μm to 5 mm. Coarse aggregates generally have a diameter distribution of more than 5 mm.

The dry mortar composition is obtainable by mixing a powdery component C containing the cementitious binder (a) and the sulfate source (d), ingredients (i) and (ii), with the calcium salt of a polyol (b). The optional extraneous aluminate source (c) is comprised in component C. The calcium salt of the polyol is preferably obtained by reaction of the polyol with the calcium compound, e.g. calcium hydroxide of calcium oxide.

The invention also relates to a mixed mortar composition comprising the dry mortar composition according to the invention and water. Preferably, the ratio of water to cementitious binder (a) is from 0.2-1.5, preferably, from 0.3-1, more preferably from 0.3-0.7 and most preferably from 0.3-0.5.

The mixed mortar composition can include besides the dry mortar composition concrete or grouts. The term “mortar” or “grout” denotes a cement paste to which are added fine aggregates, i.e. aggregates whose diameter is between 150 μm and 5 mm (for example sand), and optionally very fine aggregates. A grout is a mixture of sufficiently low viscosity for filling in voids or gaps. Mortar viscosity is high enough to support not only the mortar's own weight but also that of masonry placed above it. The term “concrete” denotes a mortar to which are added coarse aggregates, i.e. aggregates with a diameter of greater than 5 mm.

The mixed mortar composition may be provided as a dry mix to which water is added on-site to obtain the mixed mortar construction composition.

The mixed mortar composition is obtainable by mixing a powdery component C, containing the cementitious binder (a) and the sulfate source (d), and a liquid aqueous component W, wherein ingredients (i) and (ii) are contained in component C. The calcium salt of a polyol (b) is pre-mixed with component C. The optional extraneous aluminate source (c) is preferably comprised in component C or in component W. The dispersant are contained in one or both components C and W.

The sequence of addition of the optional ingredient (h), a fine material, depends primarily on the water content of ingredient (h). When ingredient (h) is provided in an essentially anhydrous form, it can conveniently be included in component C. Otherwise, and more commonly, ingredient (h) is pre-mixed with component C, and component C is blended in subsequently.

This mixing regimen prevents the immediate formation of ettringite, which would occur if the cementitious binder (a) is exposed to water without the simultaneous presence of ingredients (i) and (ii) which effectively control ettringite formation.

The invention further relates to an article obtained by the mixed mortar composition of the invention.

In context of the present invention, the article is preferably a hardened product.

The article can be obtained by the following method. The method for preparing an article comprises a step of drying the mixed mortar composition according to the invention. The drying step can be an active or an passive drying step. When the drying step is an active drying step, the drying is carried out at up to 90° C., preferably from 30° C. to 55° C. When the drying step is a passive step, the mixed mortar composition dries due to hydration and evaporation of water.

The invention is further illustrated by the appended drawing and the examples that follow.

### Methods

### Testing Procedure—Setting Time

Setting time was determined with a Vicat needle of 300 g according to DIN 196-3. Start of set was reached when the needle was stopped 3 mm above the glass plate, End of set was reached when the needle was stopped 38 mm above the glass plate. Time is given in minutes.

### Testing Procedure-Comprehensive Strength Development

The adjusted mortar mixes were each filled into mortar steel prisms (16/4/4 cm), and after 3 h at a temperature of 20° C. and relative humidity of 65%, a hardened mortar prism was obtained. The hardened mortar prism was demolded and compressive strength was measured 5 h, 1 d and 7 d after mixing according to DIN EN 13892-1.

### EXAMPLES

### Substances

For the examples and comparative examples, the following materials were used:
Retarder 1: As retarder 1 retarder 7 in indicated in table 1 of WO 2019/077050 was used
Dispersant 1: The dispersant is a Polycarboxylic ether, more specifically a copolymer of 4-hydroxybutyl monovinylether ethoxylated with 64 moles of ethylene oxide in average and acrylic acid in a ratio of 1/10 (dispersant 1 in WO 2019/077050)
Cement: CEM I 52.5 N (amount of available aluminium, calculated as Al(OH)₄⁻:0.0865 mol/100 g cement; Blaine surface area: 3401 cm²/g; amount CaSO₄/100 g cement: 0.0204 mol)

### Additive Package

Defoamer: Vinapor DF 9010 F (commercially available from BASF Construction Additive GmbH, Trostberg, Germany)
Viscosity modifier: Starvis 3040 F commercially available from BASF Construction Additive GmbH, Trostberg, Germany)

Calcium gylcerolate was prepared as follows:

A vessel was charged with 1.5 mol equivalents of glycerol. 1 mol equivalent of Ca(OH)₂ was added. The suspension was mixed and then heated to 80° C. The solid received after 7 h was cooled and ground to a fine powder, and analyzed with IR spectroscopy and XRD.

TABLE 1
Dry mortar composition

| | Comparative | | Comparative | | | |
|---|---|---|---|---|---|---|
| | Example 1 | | Example 2 | | Example 1 | |
| CEM I 52.5N | 336 | g | 336 | g | 336 | g |
| CaSO₄ anhydride | 11.2 | g | 11.2 | g | 11.2 | g |
| Quartz-sand 2-3.5 | 211.54 | g | 211.54 | g | 211.54 | g |
| Quartz-sand 0.6-1.2 | 366.38 | g | 366.38 | g | 366.38 | g |
| Ground limestone | 140 | g | 140 | g | 140 | g |
| (Omyacarb 15 AL) | | | | | | |
| Vinapor DF 9010 F | 0.3472 | g | 0.3472 | g | 0.3472 | g |
| Sodium carbonate | 2.166 | g | 2.166 | g | 2.166 | g |
| Sodium Gluconate | 0.361 | g | 0.361 | g | 0.361 | g |
| Starvis 3040 F | 0.347 | g | 0.347 | g | 0.347 | g |
| Dispersant 1 | 0.399 | g | 0.399 | g | 0.399 | g |

| | | | |
|---|---|---|---|
| Al/SO₄ ratio | 0.57 | 0.57 | 0.57 |

### Preparation of the Dry Mortar

Glycerol or calcium glycerolate was added to the dry mortar compositions indicated in Table 1. The dry mortar was produced by thoroughly mixing the powder additives.

### Comparative Example 1:1

145 liquid glycerol was sprayed on cement before mixing all the components together.

### Comparative Example 2

1.145 g liquid glycerol was sprayed on limestone powder before mixing all the components together.

### Example 1

1.627 g calcium glycerolate (mol equivalent to 1.145 g of glycerol) was added as powder before mixing all the components together.

The dry mortar was used within 2 h after mixing or was stored over a period of 2 and 15 days. For storage, a 1.0 L I bucket was filled with 1,4 kg of dry mortar and was then closed airtight. These closed buckets were stored 2 and 15 days at 21° C.

### Production of the Mortar

For producing the mortar, 190.96 g of water were added to the prepared dry mortar. The mortar was mixed according to Din EN 196-1. 5 minutes after having mixed water and the dry mortar components, flow was measured according to DIN EN 1015-3 with a Haegermann cone. Flow values are presented in Table 2 in cm.

TABLE 2

| | No storage | | | | | | 2 d storage | | | | | | 15 d storage | | | | | |
|---|---|---|---|---|---|---|---|---|---|---|---|---|---|---|---|---|---|---|
| | 5 min | Setting [min] | | Compressive | | | 5 min | Setting [min] | | Compressive | | | 5 min | Setting [min] | | Compressive | | |
| | Flow | Initial | Final | Strength [MPa] | | | Flow | Initial | Final | Strength [MPa] | | | Flow | Initial | Final | Strength [MPa] | | |
| | [cm] | set | set | 5 h | 1 d | 7 d | [cm] | set | set | 5 h | 1 d | 7 d | [cm] | set | set | 5 h | 1 d | 7 d |
| Comparative | 26.9 | 178 | 219 | 1.52 | 4.27 | 54 | 26.5 | 145 | 169 | 3.55 | 5.87 | 54.85 | 26.9 | 89 | 109 | 3.33 | 6.37 | 51.2 |
| Example 1 | | | | | | | | | | | | | | | | | | |
| Comparative | 27.5 | 202 | 240 | 3.68 | 4.57 | 59.8 | 28.5 | 103 | 131 | 3.73 | 4.69 | 55.25 | 28.7 | 81 | 97 | 3.73 | 4.91 | 55.25 |
| Example 2 | | | | | | | | | | | | | | | | | | |
| Example 1 | 25.7 | 96 | 122 | 3.48 | 7.52 | 57.45 | 26.7 | 125 | 144 | 3.41 | 7.75 | 56.6 | 27.3 | 107 | 130 | 3.19 | 8.03 | 54.25 |

It could be shown that the setting times of the inventive experiment are fluctuation within the experimental errors of a vicat experiment (+/−10%). The reduction of setting times in the Comparative Examples is strong, leading to ˜50% lower setting times after 15 d. This strong reduction of setting times is a hurdle for the production of a dry mortar and limits the applicability.

Accordingly, the inventive dry mortar composition of Example 1 show a constant setting time while exhibiting a comparable comprehensive strength.

1.-15. (canceled)

16. A dry mortar composition comprising:
(a) a cementitious binder comprising one or more calcium silicate mineral phases and one or more calcium aluminate mineral phases,
(b) a metal salt of a polyol, wherein the polyol is selected from monosaccharides, oligosaccharides, water-soluble polysaccharides, compounds of general formula (P-I) or dimers or trimers of compounds of general formula (P-I): 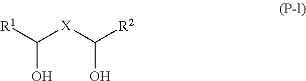
wherein X is 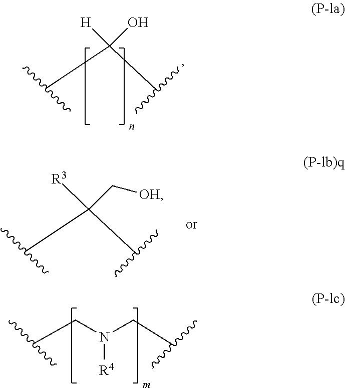
wherein
R¹ is —H, —CH₃;
R² is —H, —CH₃;
R³ is —CH₂OH, —NH₂;
R⁴ is —H, —(CH₂)ₚCH₂OH, —(CH₂)ₛCH(OH)CH₃;
m is an integer from 1 to 4;
n is an integer from 1 to 8;
p is an integer from 1 to 4;
s is an integer from 1 to 4;
(c) optionally, an extraneous alumina source;
(d) a sulfate source;
wherein the composition comprises
(e) available aluminate, calculated as Al(OH)₄⁻, from the calcium aluminate mineral phases plus the optional extraneous aluminate source, per 100 g of cementitious binder a), in a total amount of at least 0.05 mol;
and the molar ratio of total available aluminate to sulfate is 0.4 to 2.0;
the composition further comprising:
(f) an ettringite formation controller comprising (i) glyoxylic acid, a glyoxylic acid salt, a hydroxycarboxylic acid or derivative or salts thereof and/or a glyoxylic acid derivative and salts thereof; and/or mixtures of the aforementioned and (ii) a carbonate source, wherein the carbonate source is selected from inorganic carbonates, having an aqueous solubility of 0.1 g·L⁻¹ or more at 25° C.; organic carbonates; and mixtures thereof.

17. The composition according to claim 16, wherein the composition additionally comprises a co-retarder (g) selected from (g-1) phosphonic acids and salts thereof, (g-2) polycarboxylic acids and salts thereof; and mixtures thereof.

18. The composition according to claim 16, wherein the composition additionally comprises (h) a fine material having a Dv90 of less than 200 um selected from alkali-activatable binders, rock powders and inorganic pigments, or mixtures thereof, in a total amount of 20 to 200 parts by weight, relative to 100 parts by weight of cementitious binder (a).

19. The composition according to claim 16, wherein the metal salt of the polyol (b) is present in an amount of 0.15-2.5 wt.-% relative to the amount of the cementitious binder (a).

20. The composition according to claim 16, wherein the metal salt of the polyol (b) is present in a crystalline or amorphous form.

21. The composition according to claim 16, wherein the metal salt of the polyol (b) is a calcium salt of a compounds of general formula (P-I) or dimers or trimers of compounds of general formula (P-I).

22. The composition according to claim 16, wherein
the binder (a) is present in an amount of 180 to 900 kg per m³, and/or
the binder (a) has a Blaine surface area of at least 3800 cm²/g.

23. The composition according to claim 16, wherein available aluminate, calculated as Al(OH)₄⁻, from the calcium aluminate mineral phases plus the optional extraneous aluminate source, per 100 g of cementitious binder a), in a total amount of not more than 0.2 mol.

24. The composition according to claim 16, wherein the calcium aluminate mineral phases are selected from C3A, C4AF, and C12A7, in particular C3A and C4AF.

25. The composition according to claim 16, wherein the cementitious binder (a) is Portland cement, in particular ordinary Portland cement (OPC).

26. The composition according to claim 16, wherein the sulfate source (d) is a calcium sulfate source.

27. The composition according to claim 16, wherein the inorganic carbonate is selected from potassium carbonate, sodium carbonate, sodium bicarbonate, lithium carbonate and magnesium carbonate; and the organic carbonate is selected from ethylene carbonate, propylene carbonate and glycerol carbonate.

28. The composition according to claim 16, wherein the extraneous aluminate source (c) is selected from non-calciferous aluminate sources, such as aluminum(III) salts, aluminum(III) complexes, crystalline aluminum hydroxide, amorphous aluminum hydroxide; and calciferous aluminate sources such as high alumina cement, sulfoaluminate cement or synthetic calcium aluminate mineral phases.

29. A mixed mortar composition comprising the dry mortar composition according to claim 16 and water, wherein the ration of water to cementitious binder (w/c) is from 0.2-1.5.

30. An article obtained by the mixed mortar composition according to claim 29.
